(19) United States
(12) Patent Application Publication
(10) Pub. No.: US 2015/0302478 A1
(43) Pub. Date: Oct. 22, 2015

(54) Integrated System for Brand Ambassador Programmes & Co-creation

(71) Applicant: DigitalMR International Limited, Nicosia (CY)

(72) Inventor: Michalis Michael, London (GB)

(21) Appl. No.: 14/618,405

(22) Filed: Feb. 10, 2015

Related U.S. Application Data
(60) Provisional application No. 61/937,482, filed on Feb. 8, 2014.

(51) Int. Cl. G06Q 30/02; G06Q 50/00

(52) U.S. Cl. CPC G06Q 30/0257; G06Q 50/01

(57) ABSTRACT

The invention is to social media marketing, which refers to the process of gaining attention through social media sites. Corporate messages spreading from user to user resonate better because they come from a more trusted, third-party source, as opposed to the brand owner or organization itself. This form of marketing is driven by “online word-of-mouth,” meaning that it results from “earned” media rather than paid media. The present invention is to an architecture of integrated software-as-a-service platform that converts word of mouth into a mass marketing medium. As such, it has visibility across large audiences in a way similar to what newspapers, radio and television achieve.

### CROSS REFERENCE TO RELATED APPLICATIONS

This application claims the benefit of U.S. Provisional Application 61/937,482, filed Feb. 10, 2014, entitled “Integrated System for Brand Ambassador Programmes & Co-creation,” which is incorporated herein by reference.

### BACKGROUND OF THE INVENTION

### Field of the Invention

The invention is related to social media marketing tools and methods for enabling organizations to co-create digital content with their customers and then enable influencers/advocates to share it with their friends and networks. The process supports the creation and management of brand advocacy programs.

### BRIEF DESCRIPTION OF THE DRAWINGS

FIG. 1 is a flow diagram of the interoperation of some of the components of the present invention.

FIG. 2 is a flow diagram of the knowledge base subsystem according to at least one aspect of the invention.

FIG. 3 is a flow diagram of the interaction of various components and parties according to at least one aspect of the invention.

FIG. 4 is a flow diagram showing the evaluation and addition of brand ambassadors according to at least one aspect of the invention.

### SUMMARY OF THE INVENTION

The invention is in the context of social media marketing, which refers to the process of gaining attention through social media sites. Corporate messages spreading from user to user resonate better because they come from a more trusted, third-party source, as opposed to the brand owner or organization itself. This form of marketing is driven by “online word-of-mouth,” meaning that it results from “earned” media rather than paid media. Brand advocates or influencers are a managed source of “word of mouth” that share digital content with their networks and friends online allowing promoters to facilitate and/or encourage the message amplification and acceleration of shared relevant content through “online word of mouth”.

One preferred aspect of the present invention is the architecture of integrated software-as-a-service platform that converts word of mouth into a mass marketing medium. As such, it has visibility across large audiences in a way similar to what newspapers, radio and television achieve.

### DETAILED DESCRIPTION

For the purpose of illustrating the invention, the drawings show aspects of one or more embodiments of the invention. However, it should be understood that the present invention is not limited to the precise arrangements and instrumentalities shown in the drawings.

Traditionally, social media monitoring, online community platforms and customer relationship management (“CRM”) systems exist in isolation. There are cases wherein social media monitoring has been connected with a CRM system. There is however, no system that currently integrates social media monitoring, private online community platforms and CRM. The present invention provides such a system for managing the entire co-creation of digital content and advocacy or brand ambassador program as part of social media marketing.

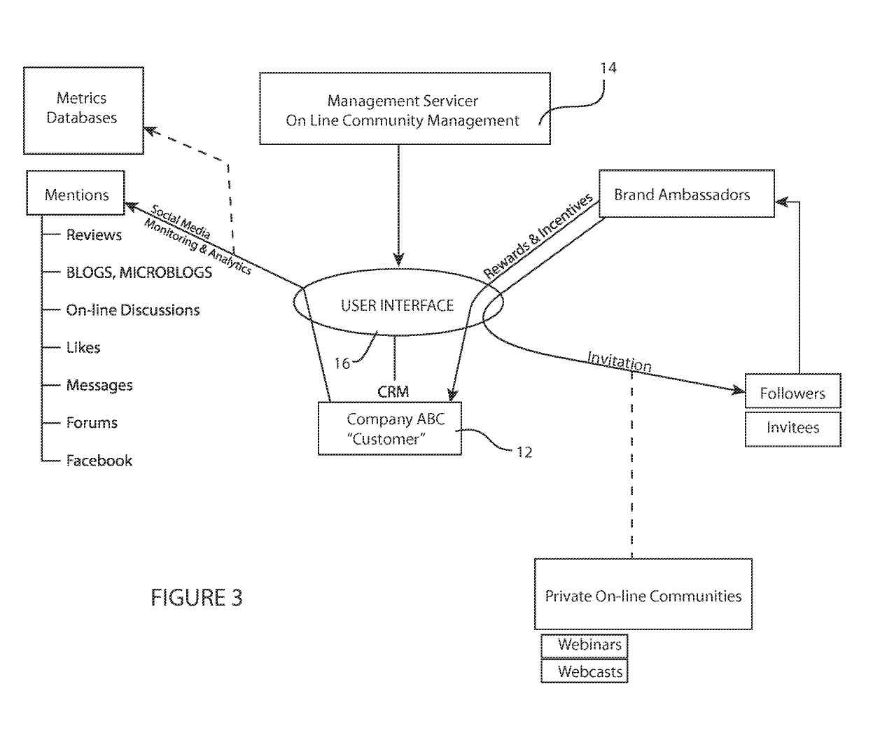

FIG. 3 is a diagram of a system architecture for one exemplary embodiment of the present invention. The integrated platform consists of the following modules: 1) Social Media Monitoring and Analytics module, 2) Online Communities platform module, 3) Connectors to multiple CRM APIs (such as for Salesforce.com, Sugar CRM or Microsoft Dynamics). These modules are organically connected and interact with each other.

As best described with reference to FIG. 3, in practice, a customer (such as a company, an organization or an individual) 12 (the “user”) desiring to amplify brand advocacy or to convert word of mouth into a mass marketing medium has a contract with the service provider 14 to obtain access to the integrated system for brand advocacy amplification 16. This may take the form of signing on to a software as a service (“SaaS”) platform or other software access model, receiving services from the integrated system to amplify and accelerate brand advocacy. Preferably, the customer 12 signs onto a website of the integrated system 14 and signs up/registers to use software-as-a-service or requests professional services for amplified customer advocacy offered by the user of the integrated system.

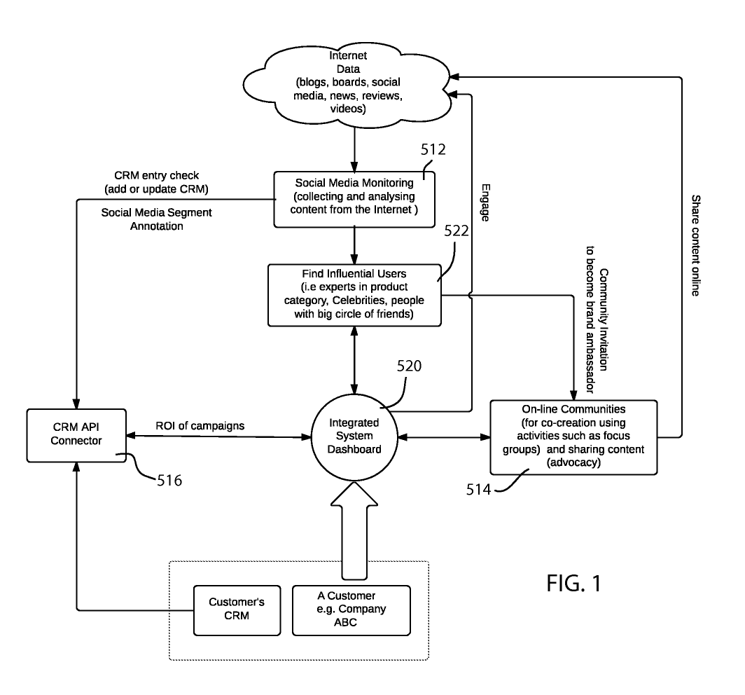

The integrated system as shown in FIG. 1 may include several components such as 1) Social Media Monitoring and Analytics 512, 2) Online Community Platform 514 and, 3) Connectors 516 to multiple CRM APIs. The registered user 12 signs on to the website to utilize the software. The user interface (Integrated System Dashboard 520) finds and uses the desired software component (“module”). The various software modules interact in order to support the processes of co-creation and amplifying word of mouth.

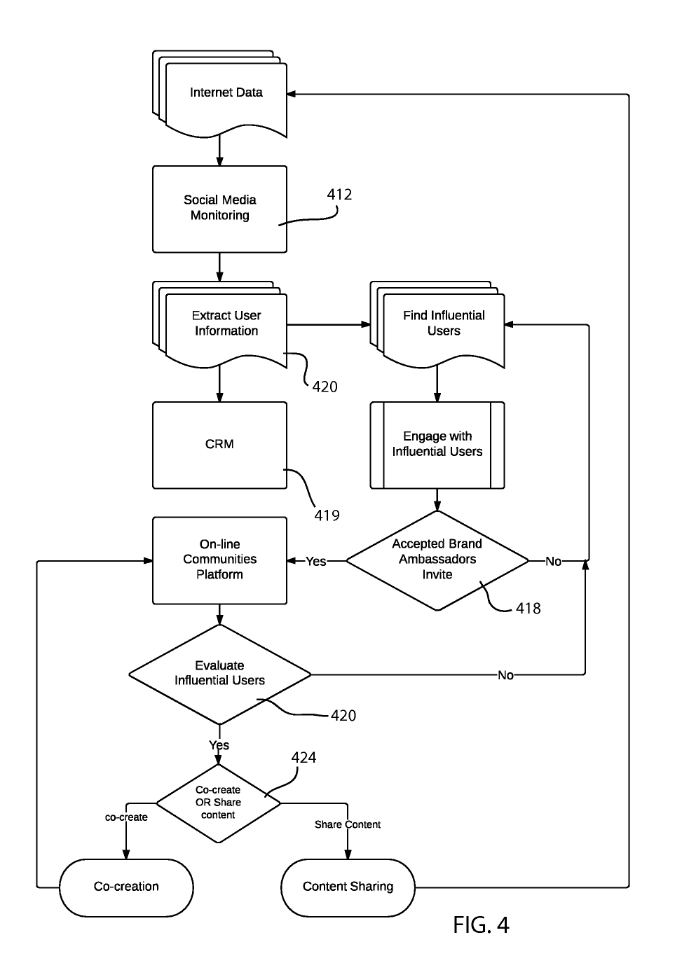

The following method as shown in part in FIGS. 1 and 4 describes a preferred method of setting up and implementing a marketing program, but a user need neither follow this specific order nor utilize all of these steps to implement the teachings of the invention:

Step 1. Define Objectives
The user decides what the specific high level objectives are. For example, the objectives may be:
   Increase my sales by 30% or by 100 million US$;
   increase my market share by 5%;
   reduce my advertising cost by 5%;
   my brand to be present with positive word of mouth on the top 50 social media networks;
   to increase the positive sentiment of my brand by 10 percentage points or to reach 75% positive share of voice;
   to reduce the negative sentiment of my brand by 10 percentage points

Step 2. Define and Find Influencers 522 and convert them to Advocates
The users can create definitions for influencers or categories of influencers, such as celebrities, journalists, bloggers, product category experts but most importantly brand lovers with a big circle of friends in social media.
The users search 414 for these influencers using the social media monitoring 412 module and engage 416 them on the social media sites where their post was found. They then invite (418) them to join the online communities platform for engagement and collaboration. Community members can also be recruited from existing followers on the user's social media assets. The Online Community Platform module can be operated as standalone or from within certain online channels such as a Facebook fan page
The user then decides who needs to be/should be engaged and motivated as part of the plan of encouraging positive, targeted posts such as product reviews, etc. by the influencers now turned to advocates.
The user continues to search the internet using the Social Media Monitoring module 419 to identify additional influencers 420 and invite them to join customer advocacy communities. This can take many subjective or objective forms, but may include items like determining who in the particular field of interest has a large influence (“large following”) on potential customers of interest. For example, if the targeted market is coffee drinkers, then a potential advocate could be a person who has posted online a specific number of times about their love for coffee and has more than 1000 Twitter followers. The user will define an influencer based on the content of their online posts and the number of followers or likes they have.

Step 3. Engage & Activate Advocates
The users can then entice advocates to invite other influencers to join the communities. This third person “work force” is a highlight of the invention by using the power of the internet to motivate third parties to carry out actions that inure to the benefit of the first party (i.e., the “user”).
The user may then use the CRM 420 to invite already identified influencers/advocates to participate in online events such as webinars, webcasts etc. The System may facilitate this process by providing databases, APIs, Apps, etc. that allow the user to use his own CRM to access information on the community 14 website when tracking or communicating with brand advocates and other members of the online community such as co-creators.
The user may use gamification to engage and reward the desired behaviour. For example, competitions may be set up so that the advocate that shares content to the most followers or signs up the most new advocates over a time period wins a prize.
The user may invite the top advocates to events in the physical world such as conferences e.g. for the bloggers among them.
The user may award advocates with redeemable points for their co-creation and content sharing activity. These points can be redeemed with gift cards, charity contributions, cash or other benefits.

Step 4. Enable Advocacy
The user may enable current customers who are pleased with the user's product or company to express themselves online so that they can start influencing other people. By using the online community managers, conversations can be initiated with the members about the user brands that will showcase their unique selling proposition. In this case, the online community module can be used to establish private online communities whereby activity tools such as bulletin boards, chat groups, video/photo diaries, may be used in a co-creation process to discuss either the user's products/services or other products/services and digital content in general.
The user may use Social Media Monitoring and the Online Communities to study the dissemination of the user's messaging from important nodes (such as key influencers).
The user will strive to increase the number of influencer nodes and strategically placed messaging.

Performance evaluation of the campaign can be key to the system's operation. Example metrics include:
How many people publicly “like” a brand;
How many followers does a brand have and how many followers do these followers have ( . . . and how many followers do the followers of the followers etc., have);
How many times a strategically placed message has been repeated by other people;
What was the possible reach of digital content that was shared by the influencers/advocates/brand ambassadors
How many positive mentions are there on the internet about a brand;
What is the share of positive and share of negative mentions on the internet;
Comparison with competition on all the above metrics.

### Social Media Monitoring & Analytics

The evaluation of the performance and the tools to find new resources to expand the campaign can rely in part on the Social Media Monitoring and analytics module of the invention. Social Media Analytics enables sentiment or emotion analysis—assessing what is being said about a topic or brand, whether it is positive, negative or neutral. Social Media Monitoring may include the following features and capabilities:
harvest posts dynamically (computer-readable media in various formats including text, images, audio and video) with data crawlers and/or APIs;
use network of computers to carry out distributed data processing;
define search terms (e.g. keywords, tags) and channels (e.g. blogs, tweets) to find relevant comments;
refine search terms via an iterative process so as to reduce noise in data (i.e., remove spurious posts);
combine machine learning algorithms (performing pattern recognition with fast setup) and computational linguistic methods (e.g. parsers, rule-based stemming);
generate statistical models that can analyse unclassified data and predict their sentiment;
boost models using training data, optionally enhanced by native human curator;
resulting method is language agnostic, i.e. can be applied to data containing different human languages;
allow system users to engage with their customers on the website where the relevant comments were found;
users will also be able to view a dashboard with sentiment analysis of the relevant posts along with information about the posters especially: number of followers or number of friends;
platform users will be able to define customer service and marketing strategies by using the system;

The invention is applicable to various contexts (i.e., product category agnostic) and market sectors FMCG/CPG, Retail, Financial Services, Automotive, Healthcare verticals etc.

### Online Communities Platform

The online communities platform may have the following features and capabilities:
The platform will be accessible by computers or computerized devices such as tablets and smartphones and other network accessible devices of any screen size;
Provides a collection of multiple native tools such as Bulletin Boards, video/photo diaries, chat groups, polls, online survey integration and a wall for informal conversations;
Users have the option to activate any tools they consider relevant and thus create a bespoke user interface;
Tools are customisable so as to allow community facilitators to easily create bespoke co-creation environments;
digital content necessary for the amplification of customer advocacy is generated (co-creation process);
Once the sharable content has been produced by the co-creators then the community for advocacy will be asked to share it with their friends and networks;
authentication data may be requested so as to authorise platform access to members;
operations performed at the user interface can be monitored;
based on the analysis of monitored data, members are motivated to co-create 424 and/or to become brand advocates 418 using gamification techniques (e.g. gaming mechanics such as achievement badges and levels) community members require notifications, for example via email, and on the platform in order to increase participation. After the user finds the influencers (potential brand advocates) the user invites them on to an exclusive online community platform and treats them as very important people (“VIPs”). Once on the community, some of the influencers will be invited to participate in co-creation discussions (to help create the next viral video clip for example) online. The invites to these engagements may be sent via email or text messages but when the co-creators register on the online community platform next time they will see in the notifications box the same invite to the engagement activity. The notification will come from the user or from the online community manager, who will be acting on behalf of the user. Increased participation means the same people who are on the community, e.g. 300 to engage in the community often and systematically contribute to more online activities such as bulletin board discussions, chat groups, video diaries, polls etc. for co-creation;
gamification techniques including the earning of redeemable points are used to motivate members to engage. The points may be redeemed with gift cards, charity contributions, discounts, prize draw participation, cash etc.

### Additional Features of the Software According to Further Preferred Embodiments

CRM API's may have the following features:
Provide connectors to the popular CRM applications so that the user's customer as a physical or legal person will be connected to their social media identities used.
Link to campaigns over multiple channels, such as email, search, social media, telephone and direct mail. That is, when a user launches a multichannel digital campaign there is usually a link that leads to a micro-site or a landing page for the campaign where the call-to-action (“CTA”) will be. The CTA could be: buy, get the discount coupon, sign-up, view video clip, download white paper etc. So this very same link to the landing page can be used in direct email campaigns to consumers or by the advocates in their posts they will be sharing with their friends and network. Specific key words will be bought from GOOGLE™ ADWORDS, for example, so that when people search for them an ad will appear on the right hand side (or top of the Google page) with a link to the campaign landing page. Also the link will appear on TWITTER™, FACEBOOK™, etc., with appropriate messaging that will entice viewers to click on the link and then take the action on the campaign landing page.

Other Plug and play software may include:
Behaviour tracking from audience tracking tools, where audience is an individual who reads or views the content and preferably potential customers of the user—requires partnership with owner loyalty card data on purchase behaviour or other transactional data observing community members through video diaries

Brand Advocacy programs:
A brand advocacy program can first be designed by the co-creation community, namely, by the customers selected based on their online posts through Social Media Monitoring. Preferably the co-creation community should include brand lovers with higher than average creativity. This group can be tapped by the user to design specifics for the brand advocacy program if one doesn't already exist.
Influencers can be recruited through the social media monitoring tool to meet certain criteria.

Co-creation:
Private Online Community tools can be used for co-creation.
Co-creation in this context is defined as the process of cooperation between the user (brand owner or other organisation) and the pre-selected influencers that enables the production of sharable digital content

The modules and components may combine multiple sources of information to synthesize insights, including:
Monitoring;
Asking questions on communities; or
Tracking behavior based on loyalty card data or audience measurement.

Additionally, the System can be used to provide an integrated platform for Social Media Monitoring, Online Community platform, top commercial CRMs, other relevant sources of information.

### Social Media Monitoring Module

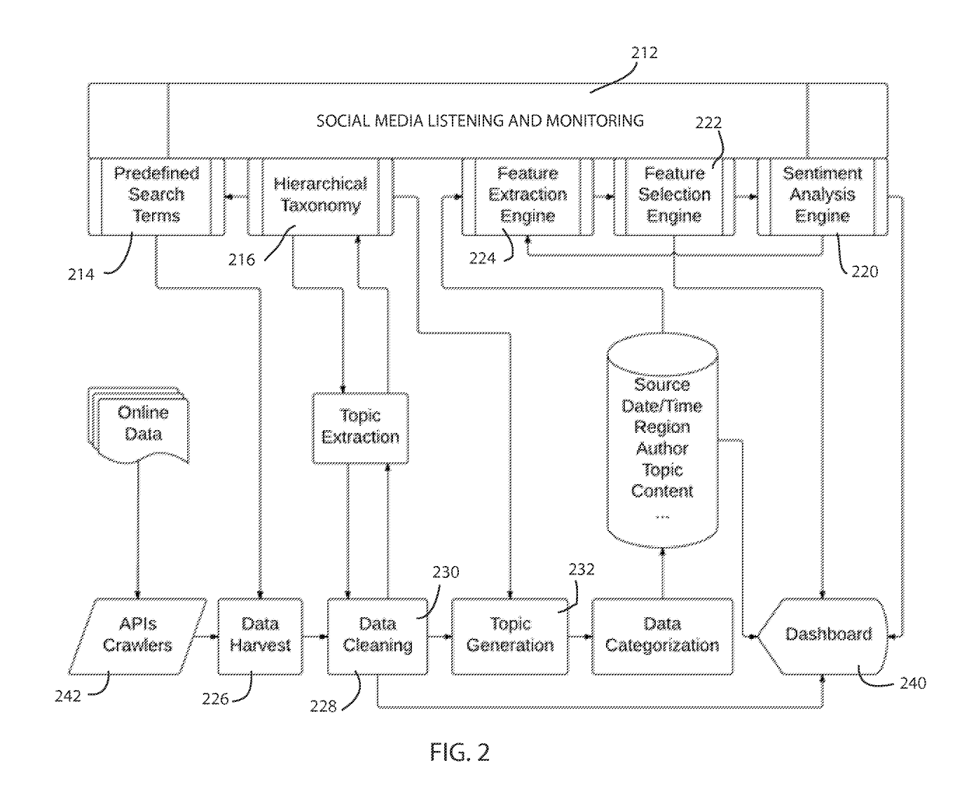

More particularly, the structure of the Social Media Monitoring module is depicted in FIG. 2. There are two major components in this structure, namely, a Knowledge Base 212 and a set of processing units. The Knowledge Base 212 stores resources with regard to expert knowledge of how to harvest most relevant data with minimum noise, i.e., predefined search terms 214, how to generate potentially insightful topics 218 for further marketing research, hierarchical taxonomy 216, and how to obtain precise sentiment analysis results, namely through a feature extraction engine 222, feature selection engine 224 and sentiment analysis engine 220. The set of processing units is composed of a series of sequential data processing steps, including Data Harvest unit 226, Data Clean unit 228, Topic Extraction unit 218, Topic Generation unit, Data categorization unit 230.

A dashboard application 240 is provided to visualize the results and to engage with interested topics. Notably, the knowledge base and processing units are not two static and separate parts, instead they are closely related to each other. Knowledge base provides the support for executing of processing units, while the results of processing units give feedback to the Knowledge Base, which can be tuned accordingly.

A detailed illustration of Social Media Monitoring platform is given below:
Data Harvest unit 226: Relevant data is harvested from online data with predefined search terms via crawlers 242 and APIs.
Data cleaning unit 228: Data cleaning is applied to the harvested data, e.g., empty entries, website urls, identifiers.
Topic Extraction unit 218: Topics are identified by extracting informative words and phrases from cleaned data. Then extracted topics from harvested data are compared with the Hierarchical Taxonomy from Knowledge Base, which can be adjusted accordingly, e.g., adding missing topics provided by Topic Extraction unit. Likewise, Data Cleaning can be adjusted based on the information provided by the Hierarchical Taxonomy. Also, the Predefined Search Terms can be adjusted if necessary. Thus, a closed feedback loop is formed to iteratively optimize the Hierarchical Taxonomy and Data Cleaning unit. If predefined search terms are refined, the Data Harvest unit can be reinitiated automatically.
Topic Generation unit 230: The optimized Hierarchical Taxonomy is applied to generate topics for cleaned data.
Data Categorization 232: Data is categorized according to the type of source, date, region, location, author information, topics and contents, etc., and stored in a structural database.
Feature Extraction and Selection Engine 224: Out of various information descriptors stored in the structural database, Feature Extraction and Selection Engine extracts and selects features closely associated with the target information content, while redundant information and less informative features are removed.
Sentiment Analysis Engine 220: Machine learning algorithms power the Sentiment Analysis Engine, which is applied to predict sentiment orientation. A feedback loop is also formed among Feature Extraction Engine 224, Feature Selection Engine 222 and Sentiment Analysis Engine 220. Each of the engines in the loop can be optimized, and others will be updated and optimized sequentially.
Dashboard 240: The Dashboard is able to display various data, e.g., the original comment, the sentiment analysis result, metadata and other information on discussion topics from a structured database.

In this way, the brand advocacy functionality of the System provides a cohesive, end to end software product for managing a user's social media marketing campaigns and can help pull together outside resources such as influencers and other online community members to co-create and share online a marketing campaign. The influence of word of mouth does not have to be a passive process of putting out a product or service and hoping that the online community will positively comment. The brand advocacy program helps the user take a proactive position to contact/influence/monitor online mentions and discussions of the product or service and systematize online word of mouth so that the reach will become similar to that of other mass marketing media. In this way, the user can help the online reputation of the product or service by increasing positive mentions while countering negative mentions of the product or service. The integrated use of Social Media Monitoring, private online community and CRM APIs allow the user to make efficient use of the software tools and data on the website using means such as the user's own Customer Relationship Management platforms.

### Example of Operation of the Method

In an example of the operation of the current inventive method, product category influencers are selected based on their comments posted online and then they by inviting them on a private online community they may be converted to customer advocates or brand ambassadors. An example of this conversion and the resulting benefits follows:

A company which owns a chain of coffee shops, for example, present in the US and in Latin America would like to leverage social media in order to grow customer traffic to their shops and by extension sales. At the same time they want to reduce their advertising expenditure while they grow sales thus achieving a double bottom-line (profit) impact.

The coffee company (“Sunbucks”) subscribes to SaaS platform that combines social media monitoring and analytics (“listening247”), private online communities (“communities247”) and a connection to their current CRM application (Microsoft Dynamics™). listening247 and communities247 may be stand-alone platforms that are seamlessly integrated on a hub for the purpose of co-creation and customer advocacy.

The Sunbucks marketing employee (“John”) who was tasked with amplifying customer advocacy logs on the hub which is hosted in the cloud by host company and starts creating a social media monitor by entering the following examples of required data in listening247:
A. Harvest online posts that include the words “coffee”+“love.”
B. Sources to be used: social media, blogs, boards, videos, review sites.
C. Language of posts: English & Spanish.
D. The poster of the comment has to have a twitter account and a Facebook account. On Twitter they have to have more than 5,000 followers.
E. Rank the comments from posters with the highest number of followers to the lowest number of followers.

The next day John checks online on the hub to find if there were any results from his monitor and he is surprised to find out that a whopping 1500 posts met his criteria. 900 were in English and 600 in Spanish.

He decides that he wants to invite the top 150 ranked users based on their twitter followers to engage with Sunbucks. He realises that in order to get 150 to engage he probably needs to contact more people. The range of followers they have from highest to lowest is 35,000 followers the top poster and 15,000 the lowest in the top 150.

He now sends a message to their social media agency with a distinct request to access the host hub (they all have login credentials) and engages with the top 300 people on the monitor ranking with the aim to actively engage with 150 of them. There is a team of social media coordinators that are dedicated to the Sunbucks account so they get right to work. They first follow the 300 people on twitter. They then retweet some of their tweets from the host hub using the official Sunbucks account and then they send them a message on Twitter along the lines: “Your posts are very relevant to what we do & would like to invite you to join the inner circle of Sunbucks marketing. Are you interested?” Another message could be: “You are invited to join a VIP community of Sunbucks to help create the next coffee experience. This comes with many privileges at Sunbucks.”

These Twitter messages include a link that if clicked will take the selected coffee category influencers to a landing page of the Sunbucks VIP community where they will need to sign-up for benefits that will be clearly described. The benefits may be:
A. You are in the inner circle of Sunbucks marketing helping to define the next coffee experience
B. With your special VIP card you have a 20% discount on all Sunbucks products
C. You will be invited to special company events in your area and will always be treated as a VIP at these events
D. For sharing digital content with your friends and network you will receive points that you will be able to redeem for gift vouchers, discount vouchers, charity contributions etc.

On the communities247 wall the 150 influencers are welcomed via video clip by the Chief Marketing Officer of Sunbucks—John's boss—who explains that the first order of business is to define the brand ambassador programme for Sunbucks. These 150 coffee lovers will co-create with the marketing department of Sunbucks the parameters of the programme; fine tune the profile of an influencer, decide the targeted number of people to be invited, the way they will be motivated, the type of content they will be sharing. This initial co-creation community can go on and continue co-creating digital content such as: video clips, recipes, white papers, webinars, podcasts, contests etc.

When the first video clip is created, it will be shared by the influencers with their friends and network with the hope that they will then share it with their respective networks and thus amplify customer advocacy or positive word of mouth for Sunbucks coffee shops.

listening247 will continue to harvest comments of influencers and will be ranking them for engagement and then invitation to an online community of brand ambassadors to hopefully reach member numbers in the thousands.

These and other objects of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

We claim:

1. A method of on line advertising through third party resources (“ambassadors”) through a customer relationship management (“CRM”) and monitoring integrated platform website, comprising:
identifying a product or service to be advertised;
identifying individuals posting online comments relating to the product or service;
selecting a first subset of identified individuals based on characteristics of the individuals;
sending invitations to said first subset of identified individuals to become ambassadors and join an on-line community.

2. The method of claim 1, wherein said characteristics of the individual is the number of on-line followers the identified individuals have registered to social accounts of the individuals.

3. The method of claim 1, wherein the integrated platform receives a list of desired characteristics for potential ambassadors and searches the internet to identify individuals posting online comments relating to the product or service, and the first subset of identified individuals is selected from the internet search list of identified individuals.

4. The method of claim 1, further comprising:
receiving responses from invitations to said first subset of identified individuals to become ambassadors;
appointing as ambassadors a second subset of identified individuals from the first subset of identified individuals;
submitting information regarding the product or service to said ambassadors;
said ambassadors posting information on-line regarding the product or service in the submitted information;
tracking the positing of information o-line regarding the product or service by the CRM.

5. A method of operating a integrated customer relationship management (“CRM”) and monitoring platform on a networked computerized device, comprising:
registering at least one individual as a customer;
receiving a request to advertise a product or service though the CRM;
determining a category for the service or product;
determining on-line users that post on-line comments relating to the category;
determining for each of the on-line users, the number of followers registered to the accounts for the respective on-line user;
selecting a first subset of the determined on-line users;
sending invitations to the first subset of determined on-line users to join an on line community;
registering on the on-line community a second subset of the invited first subset of determined on-line users.

6. The method of operating an integrated platform of claim 5, further comprising:
sending information regarding the product or service to the second subset of determined on-line users;
said second subset of determined on-line users posting information regarding the sent information about the product or service;
said CRM software tracking the posted information by the second subset.

7. The method of operating an integrated platform of claim 6, further comprising:
rating each member of said second subset of determined on-line users according to the number of positing made by each of the respective second subset of determined on-line users about the product or service.

8. The method of operating an integrated platform of claim 7, further comprising:
rewarding a third subset of determined on-line users according to their rating, wherein said third subset comprises a group of the determined on-line users having the highest ratings.

9. The method of operating an integrated platform of claim 7, further comprising tracking postings by the followers of the second subset of determined on-line users.

10. The method of operating an integrated platform of claim 7, wherein said CRM software can distinguish between one of the sentiment, content or subject matter of the postings.

11. The method of operating an integrated platform of claim 5, further comprising generating advertising electronic media by the second set of determined on-line users.

12. The method of operating an integrated platform of claim 7, wherein said CRM software combines postings from multiple social media sources.

13. The method of operating an integrated platform of claim 7, wherein the step of determining a quantity of on-line users that post on-line comments relating to the category includes:
a. harvesting posts on a network dynamically from computer-readable media in various formats including text, images, audio and video using data crawlers and/or application program interfaces (“APIs”);
b. defining search terms and channels to find relevant posts, and searching the channels for the search terms to generate the harvested posts;
c. refining search terms via an iterative process so as to reduce noise in the harvested posts; and
d. generating statistical models that can analyse the harvested posts and displaying the models on a computerized device screen for the harvested posts.

14. The method of operating an integrated platform of claim 13, wherein the channels searched includes a plurality of social media websites.

15. The method of operating an integrated platform of claim 13, further comprising predicting a sentiment from the harvested posts for each respective post.
